(19) United States
(12) Patent Application Publication
(10) Pub. No.: US 2016/0067860 A1
(43) Pub. Date: Mar. 10, 2016

(54) Nesting Kitchen Knife Set

(71) Applicants: Mark Prommel, Brooklyn, NY (US); Marco Perry, Brooklyn, NY (US); Matthew Kalish, Saugerties, NY (US); Pil Ho Chung, Jersey City, NJ (US); Kevin O'Leary, Brooklyn, NY (US)

(72) Inventors: Mark Prommel, Brooklyn, NY (US); Marco Perry, Brooklyn, NY (US); Matthew Kalish, Saugerties, NY (US); Pil Ho Chung, Jersey City, NJ (US); Kevin O'Leary, Brooklyn, NY (US)

(21) Appl. No.: 14/482,759

(22) Filed: Sep. 10, 2014

(51) Int. Cl. B25G 1/10; B26B 3/00

(52) U.S. Cl. CPC B25G 1/102; B26B 3/00

(57) ABSTRACT

A set of kitchen knives with nesting handles comprising a side with a concavity for accepting the bulbous, bulging outwardly or convex side of a handle of a slightly smaller knife in the set with all knives being nestable for space saving. When nested the convex side of one handle fits into the concavity of another handle and all blades of the knives are maintained in parallel orientation.

### BACKGROUND OF THE INVENTION

The present invention relates to sets of kitchen knives, used in connection with preparing fruit, salads, vegetables, meats, poultry, etc. in meal making in the home. Generally, these kitchen knives have coordinated handles and the blades are different as different blades serve clearly different purposes. Thus, a set of kitchen knives may have a knife blade which is serrated, for cutting bread; another knife may be a shorter paring knife, useful in taking the skin off of fruit; another knife may be a hybrid knife for cutting pineapple, having a short serrated blade but the length of the blade not being too long Another knife offered in kitchen knife sets has a large blade and is useful for carving turkey, poultry, cutting between joints of animals, etc. Other kitchen knives are for rapid dicing and cutting of fruits and vegetables, etc. The present invention relates to a set (three or more) of kitchen knives with substantially similar handles for safely and comfortably holding the same in one's hand, and, yet, the handles differ in size, while maintaining relative aesthetic and functional similarity, while the larger handles (generally associated with the larger blades of the knives) serve as nesting locations for the smaller knife blades with smaller relative handles. The nesting of knife handles, one within the other, is believed to be space saving for purposes of display, storage, and use on the kitchen counter.

### DESCRIPTION OF THE PRIOR ART

The prior art shows many sets of knives, many of which have identical handles to one another for aesthetics and comfort in using the knives. Also, knife sets have similarly shaped handles yet smaller handles for smaller blades and larger handles for larger blades. To Applicant's knowledge, however, no prior knife sets have similarly shaped and comfortable handles where the handles are designed such that the larger handle is for the larger blade and a smaller handle for a smaller blade, where the handle of the next smaller bladed knife in a set will nest within the handle of the next larger handle of the set, conserving space and, at the same time, ensuring that the blades are maintained substantially parallel to one another. The present invention solves the problems of the prior art knife sets in that it provides nesting of handles, maintaining the blades in a substantially parallel manner, and, doing so without the necessity of a knife block, a kitchen article which takes up significant counter space—a premium within many kitchens.

### SUMMARY OF THE INVENTION

The present invention is a set of knives, preferably 3 or more different knife blades, which have coordinated handles for ease and comfort of use. The handles are attached to the blades and are aesthetically related to one another and, yet, their size is proportional to the blade to which they are attached. Significantly, according to the present invention, the handles are provided with slightly concave surfaces on one side and either a flat or slightly convex surface on the other side so that one knife and its handle will be capable of being nested within the handle of another knife and, preferably, three or more knives can be nested to preserve space and to maintain, for safely and storage, the knife blades in substantially parallel orientation.

The largest knife, if desired, can be provided with a handle which is substantially flat on one side and a large (relatively) concave surface on the opposite side of the handle. This way, the flat side can rest on a table or counter top. The concave surface of that handle, however, is a nesting location for the convex (or flat) surface of the next handle in the series of decreasing in size blades of the knives. It, too, has one side of the handle with a concave surface and the other side is either flat or slightly convex. It fits within and nests and is held in the concave surface of the largest blade of the largest knife. Yet, the knife and handle nested into the largest handle provides a concave surface for the flat or convex surface of the smallest handle, for the smallest knife blade. It, too, has one side slightly concave and one side slightly convex or flat. Indeed, the smallest knife with the smallest handle can actually have one side with a convex or flat side and the other side of the handle either flat, convex or concave as, per the preferred embodiment, the smallest knife and its handle is not needed for purposes of nesting any other knife or handle.

### BRIEF DESCRIPTION OF THE DRAWINGS

FIG. 1 is a top perspective view of a knife set of three knives showing the concavity in the handles;

FIG. 2 is an enlarged and partial view of the end of one of the handles, showing the concavity therein; and

FIG. 3 is an enlarged side elevational view of the relative size (emphasized for ease of understanding) of the concavity on one side of each of the handles of the three knives and the other side having a bulbous, bulging out or convex side, and also illustrating how the smaller knife and its handle can nest into the handle and its concavity of the second or serrated/utility knife whose bulbous, bulging or convex side of its handle can nest into the concavity of the larger or third knife, that being a chef's knife.

### DETAILED DESCRIPTION OF THE DRAWING AND THE PREFERRED EMBODIMENT

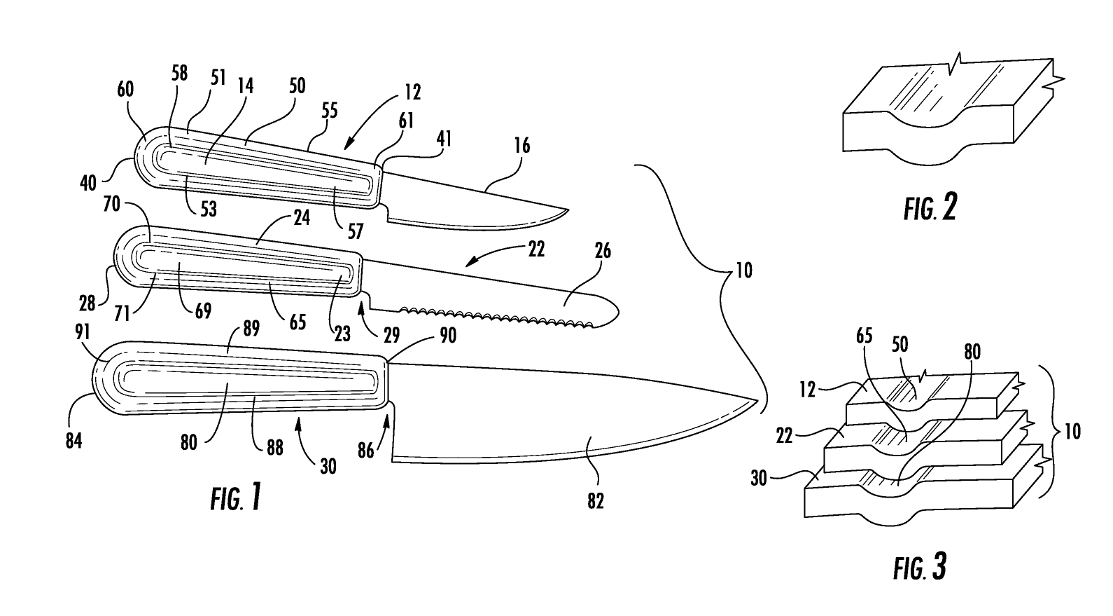

As best seen in FIG. 1, the preferred embodiment of the invention comprises a set 10 of three kitchen knives. A first paring knife 12 is provided with a handle 14 and a conventional knife blade 16 with a cutting edge suitable for paring fruits and other food preparation cutting. A second knife 22 is provided, with a slightly larger knife handle 24 and a conventional serrated and general purpose utility knife blade 26 for typical use in a kitchen for food preparation where such a general purpose and serrated edge is needed. As can be seen from FIG. 1, the handle of the second knife 22 is slightly greater in length (from proximal end 28 to the end 29 of the handle into which the blade is conventionally secured) than the length of handle 14, from its distal end 40 to its end 41, where the blade 16 is secured to the handle 14. Of course the length of the handle 14 and 24, respectively, of each knife 12 and 14, is suitable sized so that the user has a well-balanced and comfortable hand grip on the knife for ease of use. Since the blade 26 of second or utility/serrated knife 22 is longer than the blade 16 of the first knife 12 the length of the handle 24 is longer, for balance, comfort and ease of use, than the handle 14 of the first knife 12.

One side of the handle 14 of the first or paring knife 12 is preferably provided with either a concave, flat or convex surface. This is a function of the manufacturer's design and the degree of comfort, ease of use and weight for balance of the same. Preferably, however, the first side is convex with respect to a plane parallel to the plane defined by the blade 16. The first side is bulbous and extends outwardly with respect to a center plane passing through the handle. Yet, the handle comfortably fits within the grip of a user. Stated differently, the side of the handle which is not visible in FIG. 1 is convex along its length, just as much as the concavity which can be seen on the side of the knife which is visible. The two side of the handle 14 are inverse mirror images of one another, along the plane which bisects the handle and extends through the blade of the knife.

As seen in FIG. 1, the other or second side of the handle 14 is provided with a concavity 50 which because of the style of the handle depicted is a long hollow surface into the handle extending inwardly from the distal end 40 along the handle's length and to a point adjacent the end 41 of the handle. The concavity 50 preferably has a pair of opposed side walls 51 and 53 which extend substantially parallel to the sides 55 and 57 of the handle 14. These side walls 51 and 53 are somewhat aligned with the sides 55 and 57 and extend a short depth into the handle beyond the surface 60. Thus, the concavity 50 is defined in the surface of the handle 12 by side walls 51 and 53 and rear wall 58 (near distal wall 40) and front wall 61 (near the end 41).

The handle 24 of second or utility/serrated knife 22 is similar to that of the handle 14 of first or paring knife 12 but slightly larger in length and its concavity 65 is slightly deeper into the handle than that of the concavity 50 of knife 12. This is to accommodate the convex surface of the handle 14 of the first knife 12. Stated differently, the handle 14 of the first knife 12 and specifically the bulbous or convex side of the handle of the first knife fits within the concavity 65 of the handle 24 of the second knife 22. The side walls, rear and front walls of the outwardly bulging, convex or bulbous side of the first handle 14 fits within the side walls, the rear wall and the front wall of the concavity 65 of the handle 24 of the second knife 22. The concavity 65 of the handle 24 of the second (utility or serrated knife) 22 is defined by the side walls 69 and 70, a rear wall 71 near to the distal end 28 of the handle 24 and the front edge 73 near to the end 29 of the handle 24. It will be appreciated that, when desired, the first handle 14 is easily nested into the concavity 65 of the handle 24 of the second knife 22. Yet, of course, the two knives can be easily and quickly separated. The nesting is quite convenient for shipping from manufacturer to retailer, for display at the retailer, for transportation home by a purchasing consumer, and, most importantly, on a counter top or kitchen drawer, when not in use, but for saving space. When the knives are suitably nested as described, the knife blades 16 and 26 of first knife 12 and second knife 22 are parallel to one another, similar to the orientation when one or more knives are held in a knife block on a kitchen counter.

The other side of handle 24 of second knife 22 is provided with a convex, bulbous section or outwardly bulging surface. The handles of the knives, having on one side a recess or concavity and the other side having a bulging surface (about that of dimension of the concavity) is comfortable to handle, grip and allows for ease of use of the knives. The tips of one's fingers will gently and easily rest in the concavity and the convex or bulbous side of the knives rest along the inside of the fingers or into the palm of the holding hand.

According to the preferred embodiment of the present invention, a third or chef's knife 30 is provided, comprised of a third knife handle 80 and a large knife blade 82. It, too, is provided with a suitably sized (for weight, balance, use and comfort) handle 80. It is defined by a distal end 84 and an opposite end 86, where the blade is conventional attached to and secured within the handle. The handle 80 has a pair of opposed side edges 88 and 89, a curved rear edge 91 at the distal end 84 and a front edge 90. Just as the concavities 50 and 65 of the first knife 12 and the second knife 22 is present in their handles 14 and 24, the third knife 30 is provided with a concavity 80. It is configured, dimensioned and meant to hold the bulbous or convex side of the handle 24 of the knife 22. Stated differently, the handle 24 of knife 22 nests within the concavity 80 of the third or chef's knife 30. This is useful for transportation from manufacturer to retailer, for display by a retailer (minimum of shelf space), for transporting home to a consumer's kitchen and then for storage in the kitchen, whether on a countertop or in a drawer. A minimum of space and volume is occupied by the knives as a consequence of the handles being nested and nestable within one another.

As can be fully appreciated by reviewing the description and the drawings, all three knives 12, 22 and 30 nest together for economy of space and volume. Of course, since the concavity 80 or depth of the handle of the third knife 30 is deeper than the convex or bulbous section of the second handle 24 of the second knife 22 and it in turn is deeper than the bulbous or convex portion of the handle 14 of the first knife 12, clearly the first knife 12 can nest into the concavity of the third knife without the presence of the second knife and the first knife can also nest in the concavity of the second knife, as desired.

In an alternate embodiment of the invention, the handle of the smallest knife need not have a concavity at all but could be either a flat side to the handle or even also having an outwardly bulging, bulbous convex contour as it need not be capable of accepting any other handle. Similarly, the largest handle for the largest knife need not have an outwardly bulging, bulbous or convex side opposite to that of the concavity as it is unlikely to be nested in another knife. In fact, the opposite side of the handle to the concavity of the largest knife likely should be a flat side so that the same easily sits on a flat table top surface.

As can be appreciated from the present invention, when the above description is considered in view of the FIGS. 1, 2 and 3, the preferred embodiment comprises three different kitchen knives, with similar but dimensionally different handles and blades, with the smallest handle nesting in either the next smallest handle or the larger handle and with the second or middle sized handle nesting in the concavity of the largest handle. Also, with the 2 or three knives nesting within one another, handle within handle, the blades of the knives extend substantially parallel to one another, occupying minimal space and volume, which is highly desirable for storage and preservation of countertop foot print.

It will be understood by those of ordinary skill in the art that various changes may be made and equivalents may be substituted for elements without departing from the scope of the invention. In addition, many modifications may be made to adapt a particular feature or material to the teachings of the invention without departing from the scope thereof. Therefore, it is intended that the invention not be limited to the particular embodiments disclosed, but that the invention will include all embodiments falling within the scope of the claims.

1. A set of kitchen knives comprising at least three knives, each with handles and different working blades, at least two of said handles having a bulbous, convex side and at least two of said handles having a concavity side, at least one of said handles having both a bulbous, convex side and a concavity side; said bulbous, convex side of one of said handles fitting into and nesting within the concavity side of either one or both of said other handles of the other of said knives.

2. A set of kitchen knives as claimed in claim 1 wherein said knives comprise a paring knife blade, a serrated utility blade and a chef blade.

3. A set of kitchen knives as claimed in claim 1 wherein one of said handles of said knives not provided with both said bulbous, convex side and said concavity side is provided with a flat side.

4. A set of kitchen knives as claimed in claim 1 wherein two of said handles of said knives fit within and nest into the third of said handle of said third knife.

5. A set of kitchen knives as claimed in claim 1 wherein one of said knives nests within the handle of a second of said knives having both said bulbous, convex side on a handle and said concavity on the other side of said handle and said second knife nests within said handle of said third knife.

6. A set of kitchen knives as claimed in claim 1 wherein the length and width of each of said handles of said knives is coordinated in size to the length and weight of said blade of said knife to which it is secured.

7. A set of kitchen knives as claimed in claim 1 wherein the concavity of each of said handles is defined by an oval shape recessed below the top surface of the handle into which it is formed.

8. A set of kitchen knives as claimed in claim 1 wherein said handles having both a side with a concavity on one side and a bulbous, convex surface on the opposite side thereof provide a finger tip holding area and a surface conforming to the inside fingers or palm of a user's hand, respectively.

9. A set of kitchen knives as claimed in claim 1 wherein at least one of said handles is provided with a surface opposite to said bulbous, convex side with a flat surface.

10. A set of kitchen knives as claimed in claim 1 wherein the base of said concavity of one of said knives is on one side of said plane defined by said blade thereof.

11. A set of kitchen knives as claimed in claim 10 wherein said concavity on one of said sides of said knife blade having its base on one side of said plane defined by said blade thereof has its bulbous, convex side fully on the other side of said handle defined by the plane of said blade.
